(19) United States
(12) Patent Application Publication
(10) Pub. No.: US 2022/0253690 A1
(43) Pub. Date: Aug. 11, 2022

(54) MACHINE-LEARNING SYSTEMS FOR SIMULATING COLLABORATIVE BEHAVIOR BY INTERACTING USERS WITHIN A GROUP

(71) Applicant: Adobe Inc., San Jose, CA (US)

(72) Inventors: Atanu R. Sinha, Karnataka (IN); Gautam Choudhary, Rajasthan (IN); Mansi Agarwal, Madhya Pradesh (IN); Shivansh Bindal, Haryana (IN); Abhishek Pande, Maharashtra (IN); Camille Girabawe, San Francisco, CA (US)

(21) Appl. No.: 17/171,365

(22) Filed: Feb. 9, 2021

(51) Int. Cl. G06N 3/08; G06N 3/04

(52) U.S. Cl. CPC G06N 3/08; G06N 3/0454

(57) ABSTRACT

The present disclosure generally relates to techniques for predicting a collective decision made by a group of users on behalf of a requesting entity. A predictive analysis system includes specialized machine-learning architecture that generates a prediction of a collective group decision based on the captured interactions of individual members of the group.

### TECHNICAL FIELD

The present disclosure generally relates to artificial intelligence. More specifically, but not by way of limitation, the present disclosure relates to machine-learning systems that facilitate modifying an interactive computing environment or other system based on simulating collaborative behavior by interacting entities within a group.

### BACKGROUND

To simulate the collaborative behavior of multiple users within a group, machine-learning systems typically need to evaluate data representing interactions between two or more users of the group. The interactions between users of the group, however, are not observable to external entities. Without this data representing interactions between users of the group, simulating a collective user behavior performed by the group using machine-learning systems is a technically challenging task. Machine-learning systems need training data from which a model can be obtained. Given that interactions between users within the group are unobservable externally, and thus, unavailable to use a training data for the machine-learning systems, the machine-learning systems are incapable of accurately modeling a collaborative user behavior.

### SUMMARY

Certain aspects and features of the present disclosure relate to a computer-implemented method. The computer-implemented method includes identifying a set of users associated with a requesting entity. For each user of the set of users, the computer-implemented method includes accessing behavior logs associated with the user captured during a duration, generating a duration vector representation representing the behavior logs, generating a user vector representation by inputting the duration vector representation into an attention layer; and inputting the user vector representation into a second trained machine-learning model that is associated with the user. Each behavior log characterizes one or more interactions between a user device operated by the user and a network associated with a providing entity. The duration vector representation is generated using a first trained machine-learning model. The user vector representation includes one or more user-specific features concatenated with an output of the attention layer. The computer-implemented method also includes aggregating the output of the second trained machine-learning model associated with each user of the set of users into an entity vector representation representing the requesting entity. The entity vector representation includes one or more entity-specific features concatenated with an output of the second trained machine-learning model. The computer-implemented method also includes generating a prediction of a decision that the set of users will make on behalf of the requesting entity during a next duration. The decision corresponds to one or more items provided by the providing entity. The prediction of the decision is generated by inputting the entity vector representation into a third trained machine-learning model. The computer-implemented method also includes causing one or more responsive actions in response to the prediction of the decision. Other embodiments of this aspect include corresponding computer systems, apparatus, and computer programs recorded on one or more computer storage devices, each configured to perform the actions of the methods.

This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings and each claim.

### BRIEF DESCRIPTION OF THE DRAWINGS

Features, implementations, and advantages of the present disclosure are better understood when the following Detailed Description is read with reference to the accompanying drawings.

FIG. 1 depicts an example of a cloud-based computing environment for performing predictive analytics, according to some aspects of the present disclosure.

FIG. 2 depicts an example of a predictive analysis system, according to some aspects of the present disclosure.

FIG. 3 depicts another example of the predictive analysis system illustrated in FIG. 2, according to some aspects of the present disclosure.

FIG. 4 depicts an example of an activity layer of a predictive analysis system, according to some aspects of the present disclosure.

FIG. 5 depicts an example of a week layer of a predictive analysis system, according to some aspects of the present disclosure.

FIG. 6 depicts an example of an entity layer of a predictive analysis system, according to some aspects of the present disclosure.

FIG. 7 depicts an example of a process for generating a prediction of a probability of a business making a purchase from a supplier within a defined time duration, according to some aspects of the present disclosure.

FIG. 8 depicts an example of a cloud computing system for implementing certain aspects described herein.

FIG. 9 depicts an example of a computing system for implementing certain aspects described herein.

### DETAILED DESCRIPTION

Certain aspects of the present disclosure relate to machine-learning systems arranged in a specialized machine-learning architecture that facilitates modifying an interactive computing environment or other system based on simulating collaborative behavior by interacting users within a group associated with a requesting entity. The collaborative behavior performed by the requesting entity is the result of at least two types of interactions. As a first type of interaction, individual users of the group interact with each other as part of performing the collaborative behavior. As a second type of interaction, individual users of the group interact with systems external to the group (e.g., a providing entity) leading up to performing the collaborative behavior. The first type of interaction is unobservable to systems external to the group of users, such as a providing entity, and thus, the data included in these interactions are unavailable to use as training data to train machine-learning systems to simulate the collaborative user behavior. The second type of interaction, however, is available to and observable by external entities, such as a providing entities, that are external to the group. Therefore, according to certain aspects of the present disclosure, a specialized machine-learning architecture facilitates performing or otherwise causing a change to an operation of a computing environment or other system by simulating behavior of the group of users that collectively comprises or represents at least a part of the requesting entity using data detected from the second type of interaction. The simulated behavior could include, for example, a collaborative decision-making process by a group of users. The specialized machine-learning architecture simulates this behavior by, for example, applying a first machine-learning model to individual user interactions captured over a time duration at systems or platforms associated with the providing entity (e.g., the second type of interaction) to generate a duration vector representation, which is a data structure that programmatically represents the second type of interactions of an individual user associated with the requesting entity during the time duration. An example of such a first machine-learning model is a network of one or more cells of a gated recurrent unit (GRU), followed by a hierarchical attention network, which outputs the duration vector representation. The specialized machine-learning architecture also includes a second machine-learning model that receives the duration vector representation for each of one or more time durations over a larger predefined time range and outputs a user vector representation, which is a data structure that programmatically represents the interactions of an individual user over the larger predefined time range. An example of such a second machine-learning model is a network of one or more cells of a GRU, followed by a hierarchical attention network, which outputs the user vector representation. Each cell of the GRU receives a duration vector representation associated with a time duration. Additionally, the specialized machine-learning architecture includes a third machine-learning model that receives the user vector representation for each user of the group of users and outputs an entity vector representation, which is a data structure that programmatically represents the interactions of the group of users associated with the requesting entity over the larger predefined time range. An example of such a third machine-learning model is a network including a fully-connected layer for each user of the group of users, followed by an aggregation layer, which aggregates the outputs of the fully-connected layer into an aggregated vector representation. The third machine-learning model also includes another fully-connected layer, which receives as input the aggregated vector representation and outputs a prediction parameter, which is a value that is used to simulate the collective behavior of the group of users of the requesting entity.

Simulating a collective user behavior includes generating a vector representation of the interactions performed by an individual user within a time duration. In some implementations, the vector representation represents the sequence of interactions that occurred during the time duration. In other implementations, the vector representation represents the frequency distribution of interactions performed by an individual user of the group within the time duration. A predictive analysis system modifies the components of the specialized machine-learning architecture based on how the interactions are represented (e.g., either by sequence of interactions or by frequency distribution of interactions). The providing entity selects or otherwise determines the manner in which the interactions are represented. Regardless of how the interactions are represented, the specialized machine-learning architecture generates a prediction parameter that simulates the collective behavior of the group on behalf of the requesting entity in response to applying the first, second, and third machine-learning models to those interactions.

In some implementations (e.g., when the interactions are represented as a sequence), the specialized machine-learning architecture includes an activity layer, a duration layer, and an entity layer. The activity layer is configured to receive as input behavior logs including time-stamped interactions of each user of the group of users that occurred within the time duration, and to output a vector representation of the time-stamped interactions for that time duration for each user. For example, the activity layer outputs a vector representation of the interactions between one user and the website of the providing entity (or an interaction caused by one user of the group sending an email to an email account associated with the providing entity). The activity layer includes one or more GRUs, which are configured to detect patterns within the time-stamped interactions for each user, and a hierarchical attention network, which is configured to automatically identify interactions to focus on as relevant or contextual information with respect to predicting the collective decision made by the group of users. The hierarchical attention network is specialized to simulate or model group decision-making, such as the group of users making the decision of whether or not to request an item from the providing entity. The specialized machine-learning architecture also includes a duration layer, which is configured to receive as input the vector representation of each time duration over a time period (e.g., a vector for each week over the course of a month) for an individual user, and to output a vector representation that represents the user over the time period (e.g., a month). The time period is a rolling time period (e.g., the most recent four weeks) that includes the previous one or more time durations (e.g., the previous four weeks). The duration layer includes one or more GRUs, which are configured to detect patterns within the vector representation of the time duration for each user (e.g., this GRU receives the vector representing each week over four weeks), and a hierarchical attention network, which is configured to automatically identify vector representations (representing time durations) to focus on as relevant or contextual information with respect to predicting the collective decision yet to be made by the group of users. The output of the duration layer is a vector that represents the individual user of the group of users. One or more user-specific features are concatenated to the output of the duration layer. For example, a user-specific feature is the job title of the user, the name of the requesting entity, the department in which the user is employed, and any other suitable static feature that characterizes an aspect of the individual user. The entity layer is configured to receive as input the vector representing each user (with the concatenated features) of the group of users. The entity layer includes a fully-connected neural network for each user of the group of users. The output of each fully-connected neural network is aggregated using aggregation techniques described in greater detail below to a final prediction of the decision that the group of users is yet to make for the next time duration (e.g., the next week). The final prediction is a prediction parameter that is represented as any value. Further, the prediction parameter is used as a simulation or modeling of a collective behavior of the group of users associated with the requesting entity based on the individual interactions of the users. The hierarchical attention networks described above are exemplary, and thus, the present disclosure is not limited thereto. Other natural language processing (NLP) machine-learning models are usable for the activity layer and the duration layer.

In other implementations (e.g., when the interactions are represented as a frequency distribution), the predictive analysis system modifies the specialized machine-learning architecture to include the duration layer and the entity layer, and to not include the activity layer. Removing the activity layer simplifies the specialized machine-learning architecture, which causes an improvement to the performance or functioning of the servers executing the predictive analysis system. The improvements to the performance or functioning of the servers include computer-based improvements in terms of speed and reduced processing resources (e.g., the modified specialized machine-learning architecture is compute light) involved in generating the prediction parameter. In these implementations, instead of generating a duration vector representation of the interactions of a given user within a given time duration (e.g., the output of the activity layer, where the sequence of interactions are relevant to the final prediction), the duration vector representation is represented as a frequency distribution of the interactions that a particular user performed within the associated time duration. For example, the duration vector representation is a vector of length nine, such that each element of the vector represents one of nine different types of interactions.

The specialized machine-learning architecture outputs a prediction parameter (e.g., a value) to simulate a collective behavior of the group of users during a future time duration (e.g., next week). The prediction is based on the interactions of each individual user that occurred within at least a previous time duration (e.g., last week). The prediction parameter, which is the output of the specialized machine-learning architecture, is a numerical value that programmatically represents a simulation of a collective user behavior (e.g., group-based decision making). Further, the simulation of the collective user behavior programmatically causes a modification in an interactive computing environment or facilitates performing or otherwise causing a change to an operation of a computing environment or other system.

Any of the two implementations described above (e.g., when the interactions are represented as a frequency distribution or when the interactions are represented as a sequence) may be selected by a providing entity or may be automatically selected depending on the computing environment. Additionally, the present disclosure is not limited thereto, and thus, these two implementations are disclosed for the purpose of illustration and other implementations are possible.

The specialized machine-learning model, as described in various implementations herein, solves a previously unaddressed technical problem. The providing entity does not observe or have access to data signals representing internal communications between users of the group of users associated with the requesting entity. Accordingly, prior to the various implementations of the present disclosure described herein, due to the unobserved content of communications between users of the group, the providing entity could not simulate a collective behavior of the group of users associated with the requesting entity for a future time duration. Thus, the various implementations of the present disclosure provide an improved technical result or an improvement to the functioning of a computer by executing a compute-light specialized machine-learning architecture to generate simulations of collective behavior of a group of users associated with a requesting entity without any data signals indicating the group members' internal communications with each other, but rather by processing individual user interactions with the providing entity using the specialized machine-learning architecture. Additionally, the prediction analysis system uses the result of the simulation of the collective user behavior to programmatically cause modifications to interactive computing environments or other systems.

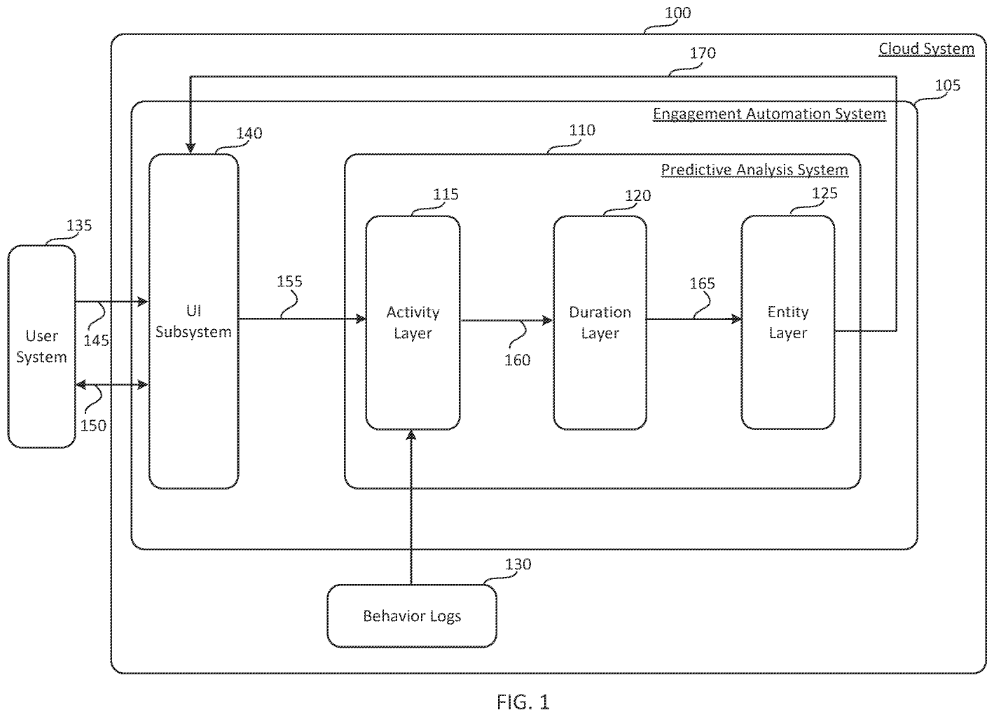

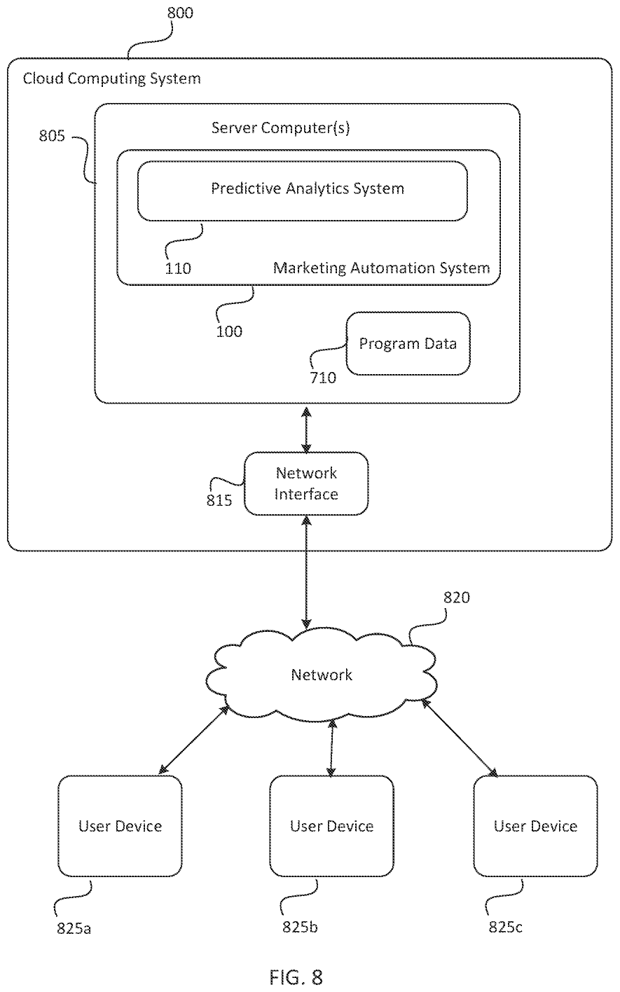

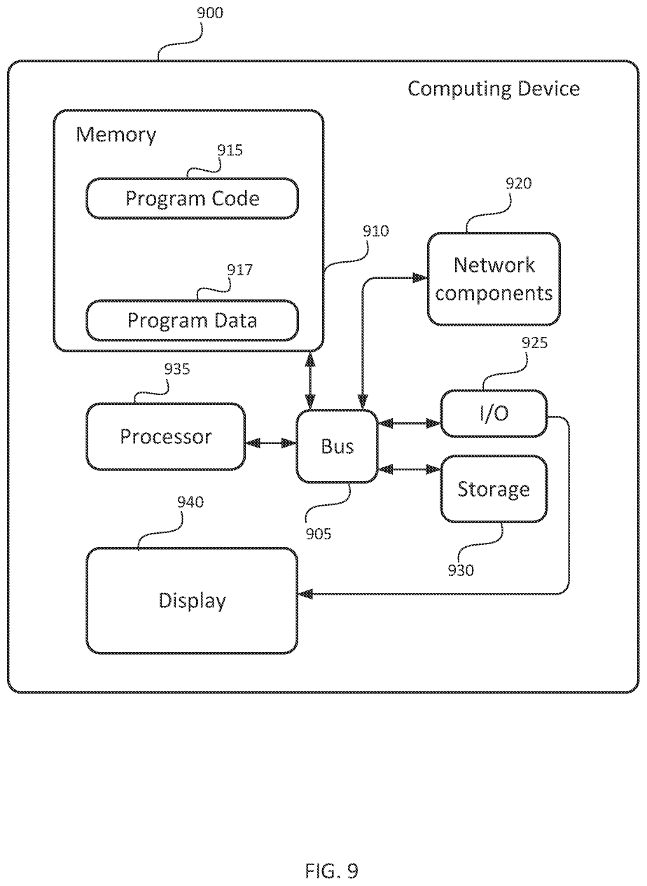

FIG. 1 depicts an example of a cloud-based computing environment for performing predictive analytics, according to some aspects of the present disclosure. In this example, FIG. 1 illustrates a cloud system 100. Cloud system 100 includes any suitable cloud-based computer system including, for example, server computer 805 of FIG. 8 and/or computing device 900 of FIG. 9. User system 135 is any suitable computer system including, for example, any of user devices 825a-c of FIG. 8 and/or computing device 900 of FIG. 9. A user may utilize user system 135 to access the cloud system 100 via user interface (UI) subsystem 140.

In certain implementations, the cloud system 100 provides an engagement automation system 105 that is configured to automatically communicate with user devices. The engagement automation system 105 incorporates a predictive analysis system 110 configured to provide predictive analysis functionality for providing entities (e.g., suppliers or vendors). The predictive analysis functionality includes machine-learning techniques that generate predictions of certain activity, such as predictions of decisions of a group of users (e.g., leads) associated with a requesting entity. Non-limiting examples of decisions of a group of users include a potential existing or new buyer of items from a supplier in a business-to-business context (where the buyer has been retained or not yet retained), a family or business seeking to purchase a property, or any suitable situation in which a group of users make a collective group decision and the internal communications between the group are not observed, however, each member of the group interacts with an external platform. In certain implementations, cloud system 100 provides users with machine-learning-based analytical functionality, including marketing services and other search engine optimization functionality. In some implementations, a user is an individual user. In other implementations, the user is an aggregation of multiple users treated as a single user.

Engagement automation system 105 may be implemented using software, hardware, firmware, or any combination thereof. In some implementations, the engagement automation system 105 includes UI subsystem 140 that communicates with a user system 135 operated by a user (e.g., a user associated with a providing entity). The engagement automation system 105 also includes the predictive analysis system 110 for performing some or all of the engagement automation system 105 functionality (e.g., automatically predicting a group decision collectively made by the users within the group, as described herein).

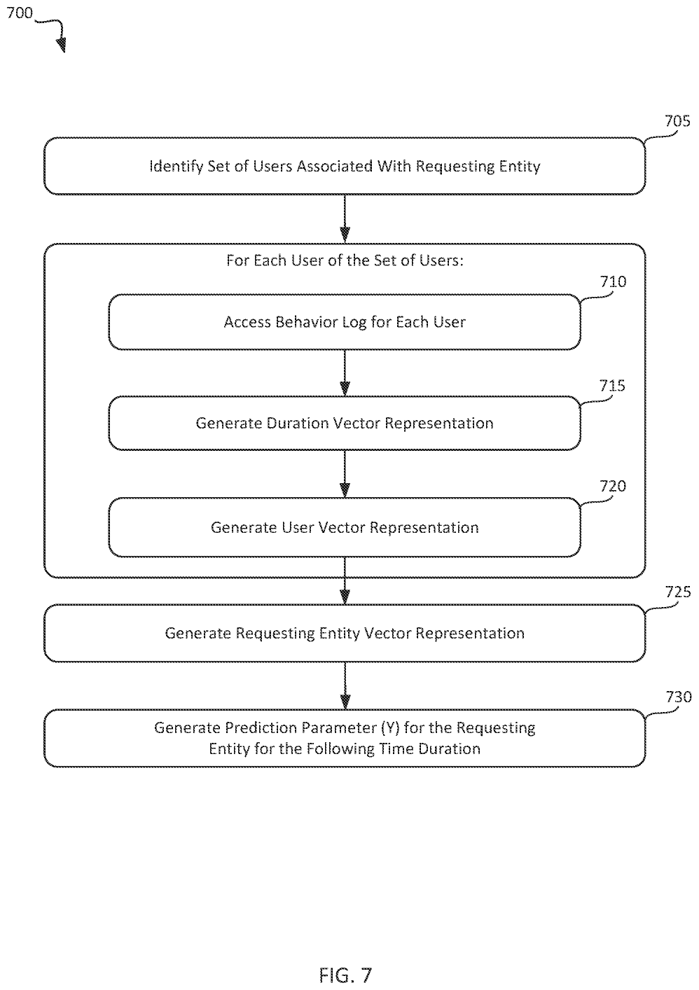

Predictive analysis system 110 executes a specialized machine-learning architecture to predict a probability that a requesting entity (e.g., a potential buyer) will request (e.g., purchase) an item (e.g., a product or service) from a providing entity (e.g., a supplier). Examples of a process for generating the prediction using the specialized machine-learning architecture are described in more detail with respect to FIG. 7.

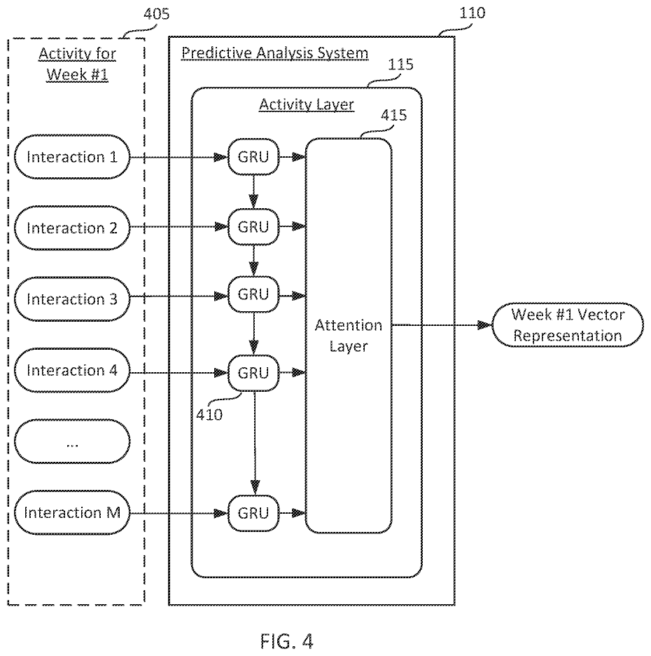

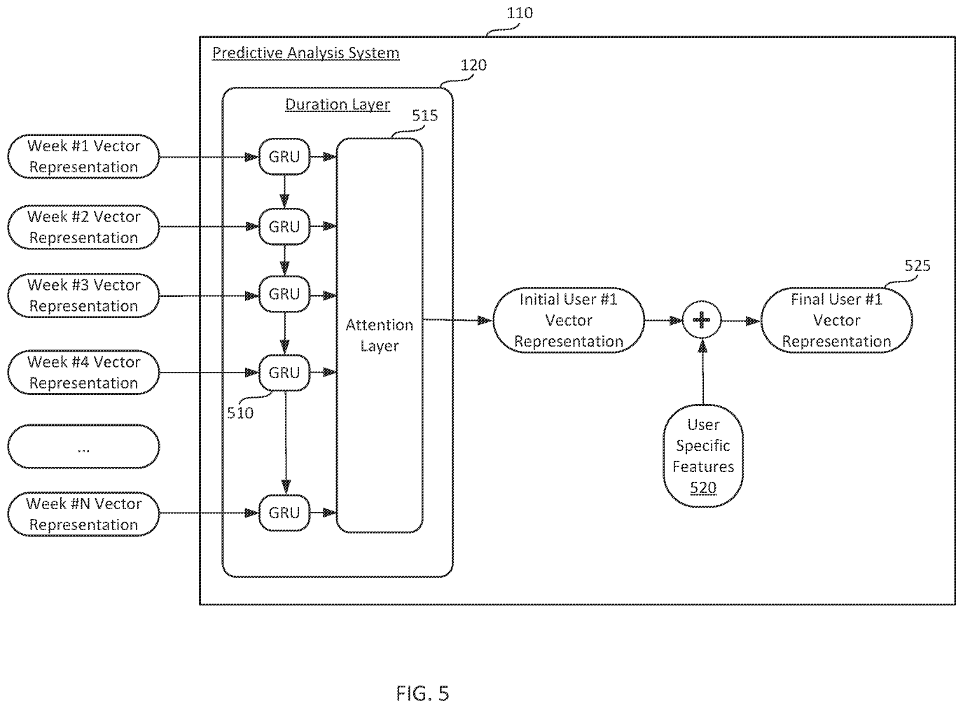

In some implementations, the predictive analysis system 110 includes an activity layer 115, a duration layer 120, and an entity layer 125. The activity layer 115 receives as input a user's behavior log for a given time duration (e.g., one week). The behavior log is a record of a time-stamped sequence of interactions between a user device operated by the user and the providing entity (e.g., a phone call the user initiated to a call center operated by the providing entity, or the user interacting with the website of the providing entity). The activity layer generates a vector representation of the interactions included in that behavior log for that user over the time duration (e.g., over the last week). As described in greater detail with respect to FIG. 4, the activity layer includes a hierarchical attention network that is trained to identify the interactions to focus on that are relevant with respect to predicting the group decision. The vector representation for the user's interactions that occurred within the time duration for one or more time durations (e.g., the vector for each week over four weeks) is then passed through the duration layer 120. As described in greater detail with respect to FIG. 5, the duration layer 120 also includes a hierarchical attention network that is trained to identify the interactions to focus on that are relevant with respect to predicting the group decision. The duration layer 120 outputs a vector representation of the user over the course of a rolling window (e.g., a vector representation of the user's interactions with the providing entity over the last four weeks). In the same fashion, the duration layer 120 outputs a vector representation for each other user of the group of users associated with the requesting entity. The vector representation of each user (which is concatenated with user-specific features) is then passed through the entity layer 125, which includes a separate fully-connected layer for each user of the group of users. The outputs from the fully-connected layers are aggregated to generate an aggregated output. The aggregated output is then passed through a single fully-connected neural network to generate the prediction parameter outputted by the entity layer 125. The prediction parameter represents the final prediction of the decision yet to be collectively made by the group of users for the next or following time duration. Several implementations of aggregation techniques for aggregating the outputs of the fully-connected layers are described herein. The predictive analysis system 110 causes one or more actions to be automatically performed in response to the prediction parameter outputted by the entity layer 125. The actions may include automatically modifying the content of a digital communication targeted to be transmitted to a user device of the user, generating an alert notification of the prediction parameter to the providing entity, automatically determining an amount of resources (e.g., number of items reserved for the requesting entity or number of sales representatives) to allocate to the requesting entity, or any other suitable action automatically or manually performed.

To illustrate the predictive analysis system 110 in use, and only as a non-limiting example, an individual (e.g., a person employed by a supplier) operates the user system 135 to access an interface provided by the engagement automation system 105. The user selects a requesting entity for which a prediction of the group's decision is requested (indicated by arrow 145), and then triggers the predictive analysis functionality provided by the engagement automation system 105 or provides other information, such as an identity of each user of the group of users associated with the requesting entity (indicated by arrow 150) using the interface that is displayed or provided on user system 135. Other communications may be transmitted or received indicated by arrow 150. The UI subsystem 140 receives the selection of the requesting entity and the indication to execute the predictive analysis functionality. The UI subsystem 140 transmits the received information to the predictive analysis system 110 as an input (indicated by arrow 155). The activity layer 115 retrieves behavior logs associated with each user of the group of users from the database 130. The activity layer 115 processes the behavior logs to generate a duration vector representation for each time duration of a plurality of time durations (e.g., a vector for each week of the previous four weeks). The activity layer 115 transmits the duration vector representation for each time duration to duration layer 120 (as indicated by arrow 160). The duration layer 120 receives the duration vector representation for each time duration and processes the duration vector representations over a rolling window (e.g., the last four weeks). The duration layer 120 generates a user vector representation for each user of the group of users. A user vector representation numerically represents the interactions of a particular user over the course of the rolling window. One or more user-specific features associated with the particular user are concatenated to the user vector representation for that user. This is performed for each user of the group of users. The user vector representation (together with the user-specific features) for each user of the group of users are inputted into the entity layer 125 (indicated by arrow 165). The entity layer 125 includes a fully-connected layer associated with each user. Thus, the concatenated user vector representation representing a user is inputted into the fully-connected layer for that user. Each fully-connected layer generates an output. The entity layer 125 includes an aggregation layer that is configured to aggregate the outputs of the various fully-connected layers using one or more aggregation techniques. Then, one or more features specific to the requesting entity and the aggregated output are concatenated, and the result is then passed through a single fully-connected layer to generate the final prediction parameter (as indicated by arrow 170). The final prediction parameter is then transmitted to UI subsystem 140 for presenting on the interface. The individual machine-learning models included in each layer, as described above, are disclosed by way of example, and thus, the present disclosure is not limited to the examples of machine-learning models described above.

While only three components are depicted in the predictive analysis system of FIG. 1 (e.g., the activity layer 115, the duration layer 120, and the entity layer 125), the predictive analysis system 110 includes any number of components or neural network layers in a pipeline.

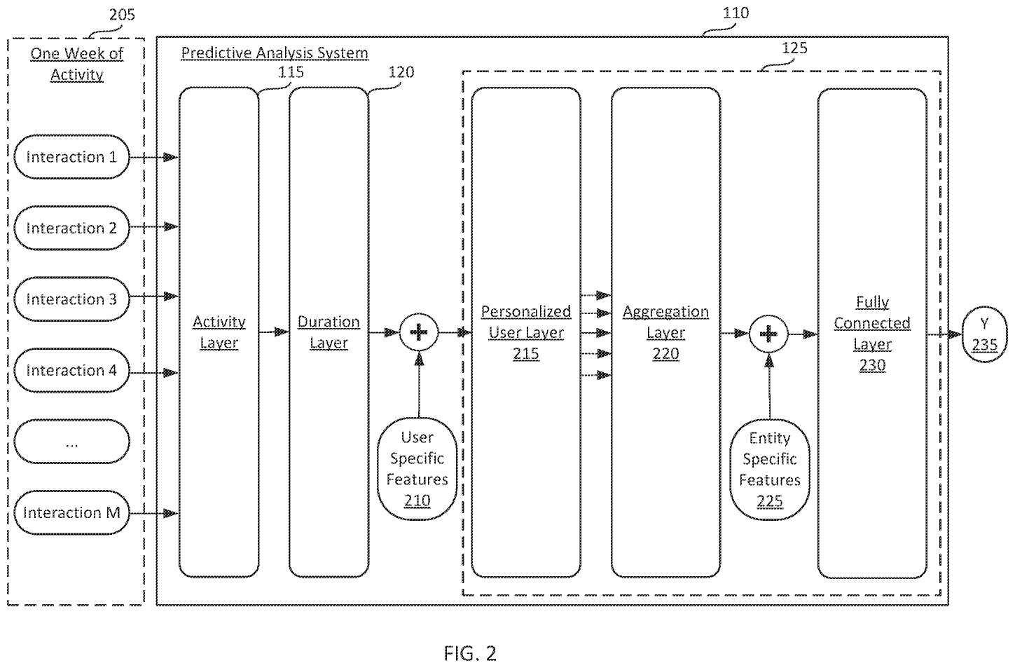

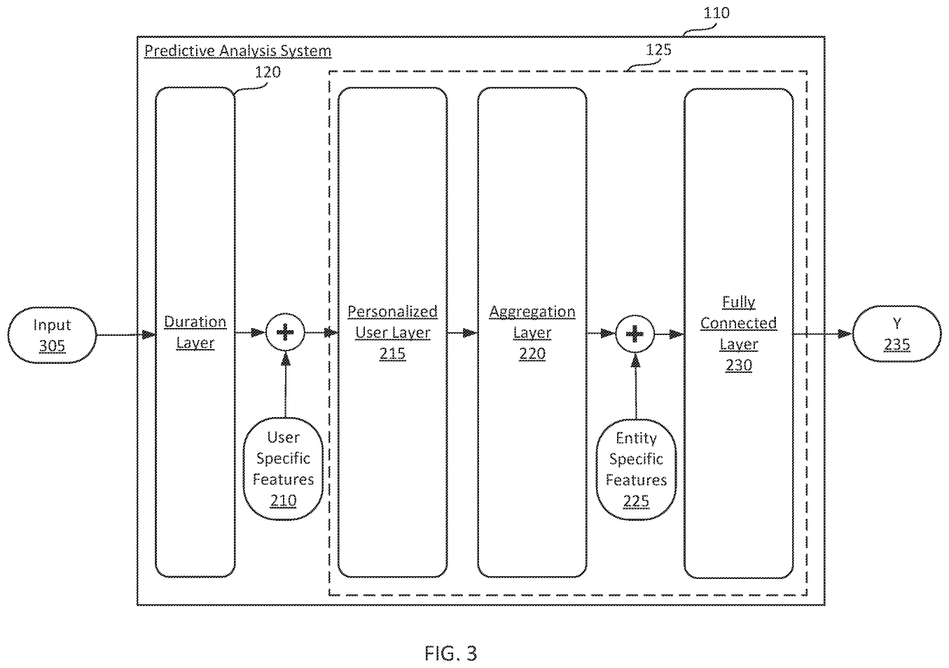

FIGS. 2-3 depict various examples of the predictive analysis system 110, according to some aspects of the present disclosure. The predictive analysis system 110 in the illustrative examples of FIGS. 2-3 is configured for use by an individual associated with a providing entity (e.g., a supplier). The providing entity provides items to one or more requesting entities upon request. The individual of the providing entity operates a computing device to load an interface that enables access to the predictive analysis system 110. The predictive analysis system 110 generates a prediction parameter (indicated by output Y 235) in response to evaluating a behavior log 205 for a specific user as an input. The specific user is one of the members of the group of users making a collective decision on behalf of a specific requesting entity. The output Y 235 represents the predictive analysis system 110 predicting a probability that the specific requesting entity will request an item from the providing entity during a defined time duration in the future (e.g., the following week). Similar to the illustration of predictive analysis system 110 in FIG. 1, the predictive analysis system 110 shown in FIG. 2 also includes the activity layer 115, the duration layer 120, and the entity layer 125.

In the example shown in FIG. 2, the individual of the providing entity uses the interface to configure the predictive analysis system 110 for evaluating the sequence of interactions performed by the user of the group of users (as opposed to the frequency distribution of the interactions). Accordingly, with this configuration selected, the predictive analysis system 110 includes the activity layer 115. When the individual configures the predictive analysis system 110 for evaluating the frequency distribution of the interactions of the user (as opposed to the sequence of interactions), then the predictive analysis system 110 does not include or use the activity layer 115, as illustrated in FIG. 3.

Referring to FIG. 2, the behavior log 205 captures the time-stamped interactions between a specific user of the group of users who are tasked with making a collective decision on behalf of a specific requesting entity. For example, behavior log 205 includes Interactions 1 through M, which were captured during a defined time duration in the past (e.g., the previous week). Each of Interactions 1 through M is captured when a user device operated by the user interacts with any component of a network associated with (e.g., operated by) the providing entity. Non-limiting examples of interactions between the user device operated by the user and the network associated with the providing entity include the user operating a laptop to load and interact with the providing entity's web site, the user operating a phone to call a call center operated by the providing entity, the user operating a computer to send an email to an email address associated with the providing entity, and any other suitable interaction. The network associated with the providing entity captures the interaction when it occurs and stores the interaction (or a representation of the interaction), along with the time-stamp of the interaction and an identifier of the user involved in the interaction. Additionally, Interactions 1 through M of behavior log 205 occurs in an ordered sequence. For example, Interaction 1 occurs at 10:00 AM and represents the user accessing a specific page of a website associated with the providing entity; Interaction 2 occurs at 10:02 AM and represents the user selecting a link that navigates the user to technical documentation relating to an item; Interaction 3 occurs at 10:10 AM and represents the user calling the providing entity for more information on the technical documentation relating to the item; and so on. The ordered sequence of interactions spans any range within the time duration associated with the behavior log 205.

As described with respect to FIG. 1 above, the behavior log 205 is inputted into the activity layer 115. The activity layer 115 generates a vector representation to represent the time duration over which the behavior log 205 was captured (e.g., a vector representing a week of interactions from a user). The activity layer 115 uses techniques described with respect to FIG. 4 to generate the vector representation for the time duration (e.g., also referred to as the duration vector representation). The vector representation for the time duration that is outputted from the activity layer 115 is then inputted into the duration layer 120. The duration layer 120 also receives one or more vector representations representing other previous time durations. For example, the duration layer 120 also receives four vector representations: a first vector representation representing the user's interactions within a first week (e.g., as detected from or included in a behavior log), a second vector representation representing the user's interactions within a second week (e.g., as detected from or included in a behavior log) that immediately follows the first week, a third vector representation representing the user's interactions within a third week (e.g., as detected from or included in a behavior log) that immediately follows the second week, and a fourth vector representation representing the user's interactions within a fourth week (e.g., the most recent week, which corresponds to behavior log 205) that immediately follows the third week. The duration layer 120 uses techniques described with respect to FIG. 5 to generate a vector representation representing a specific user's interactions over a rolling window (e.g., a user vector representation). For example, a rolling window is four weeks in the past. The output of the duration layer 120 and one or more user-specific features 210 are concatenated. For example, a user-specific feature is a static value, such as the user's job title.

The vector representation of the specific user's interactions over the rolling window (including the concatenated one or more user-specific features 210) are then inputted into the entity layer 125. The entity layer 125 is configured to include a personalized user layer 215, an aggregation layer 220, and a fully-connected layer 230. The personalized user layer 215 includes a fully-connected layer for each user of the group of users. For example, a fully-connected layer is a neural network, in which every neuron in one layer is connected to every neuron in another layer. The personalized user layer 215 generates a vector output for each user of the group of users. The multiple vector outputs of the personalized user layer 215 are then inputted into the aggregation layer 220 to be aggregated.

The aggregation layer 220 aggregates the multiple vector outputs received from the personalized user layer 215, the aggregated vector outputs are concatenated with one or more entity-specific features (e.g., size of the requesting entity, industry of the requesting entity, etc.), and the concatenated vector is then inputted into the fully-connected layer 230 to generate the output Y 235. In some implementations, the aggregation layer 220 aggregates the user vector representation and the one or more entity-specific features 225 using a feedforward neural network. The number of hidden layers of the feedforward neural network is changeable by the individual associated with the providing entity. As an illustrative example, the aggregation layer 220 includes two hidden layers followed by a Sigmoid layer to generate the output as a probability of that the collective decision of the group of users will be to request an item from the providing entity. In other implementations, the user vector representation for each user of the group of users is passed through a many-to-many GRU layer. The output from the many-to-many GRU layer is then passed through an attention layer. The output of the attention layer along with the one or more entity-specific features is then inputted into the fully-connected layer 230 (e.g., a fully-connected feedforward neural network) to generate the output Y 235 (e.g., the prediction parameter). In other implementations, the aggregation layer 220 includes a many-to-one GRU to generate the output Y 235. For example, user vector representation for each user is passed through a many-to-one GRU layer. The output from the many-to-one GRU, along with the one or more entity-specific features is then inputted into the fully-connected layer 230 (e.g., a fully-connected feedforward neural network) to generate the output Y 235, which represents the prediction parameter. In other implementations, the aggregation layer 220 includes logic for determining the output Y 235. For example, the logic includes the following condition: “If exactly one user decides to request an item from the providing entity, then the requesting entity is predicted to request the item from the providing entity.” In this example, the likelihood that the collective group of users will decide to request the item from the providing entity is determined by identifying the user vector representation that has the maximum value. The user vector representation that was identified as having the maximum value is used as the prediction of the decision for the requesting entity. Alternatively, the logic includes the following condition: “If at least one user decides to request an item from the providing entity, then the requesting entity is predicted to request the item from the providing entity.” In other implementations, the aggregation layer 220 aggregates the user vector representations by computing a geometric mean of the user vector representations. The present disclosure is not limited to the aggregation techniques described above.

Referring to FIG. 3, when the individual of the providing entity configures the predictive analysis system 110 to evaluate the frequency distribution of the user's interactions with the network of the providing entity, then the activity layer 115 is not included in the predictive analysis system 110. Instead, the input 305 is a vector of a defined length. Each element of the vector represents the frequency of one of various different interactions types. For example, the first element of input 305 represents a number of times the user of the group of users accessed a website associated with the providing entity, the second element of input 305 represents a number of times a technical document was downloaded by the user of the group of users, and so on. The input 305 is passed directly into the duration layer 120, which is a simpler architecture than the predictive analysis system 110 shown in FIG. 2. The remainder of the predictive analysis system 110, as illustrated in FIG. 3, is the same as the predictive analysis system 110, as illustrated in FIG. 2.

FIG. 4 depicts an example of the activity layer 115 of the predictive analysis system 110, according to some aspects of the present disclosure. As illustrated in FIG. 4, behavior log 405 is similar to behavior log 205, in that behavior log 205 represents Interactions 1 through M performed by a user of the group of users during week #1. Each interaction of Interactions 1 through M is inputted into GRU 410, as shown in FIG. 4. The GRU 410 is trained using previous behavior logs of other users to detect patterns within the Interactions 1 through M and decide which information is passed on as output. The GRU 410 includes a plurality of cells, such that each cell is associated with one of the Interactions 1 through M. The outputs of the GRU are then passed to attention layer 415. For example, the attention layer 415 is a hierarchical attention network. The attention layer 415 is trained using previous behavior logs to detect which interactions to focus on (e.g., to attend to), and this information is passed on as contextual information in the form of Week #1 Vector Representation. The Week #1 Vector Representation is then passed on to the duration layer 120 (not shown in FIG. 4). Additionally, the Week #1 Vector Representation is used to obtain weights for each user of the group of users, which is then used as a proxy measure of influence of the user in the final prediction (e.g., the prediction parameter).

In some implementations, a Long-Short-Term-Memory (LSTM) network is used, instead of the GRU 410, to detect patterns within Interactions 1 through M of behavior log 405. The LSTM is trained for time series forecasting, which takes into account the time difference between the occurrences of two events.

In some implementations, the activity layer 115 executes the following equations to generate the Week #1 Vector Representation:

Notations (for a single requesting entity):

M=The number of users in the group associated with the requesting entity.

N=The maximum number of interactions performed by the group of users within a week.

L₂₃¹=The third interaction of user #2 in week #1.

Y₂₃¹=The output of the third LSTM associated with user #2 in week #1.

h₂₃¹=The third activation of user #2 in week #1

Z¹=The probability that the requesting entity will request an item from the providing entity after week #1.

P (Previous Activation Vector)=<h_{1N}¹, h_{2N}¹, . . . h_{MN}¹>=The dynamic vector representing the activation of the last LSTM block of the previous week for each user.

rₜ=a reset gate in the GRU 410.

gₜ=an update gate in the GRU 410.

Equations for a GRU cell of the GRU 410:

gₜ=σ(W_{g}Lᵢⱼ+U_{g}hₜ₋₁+b_{g}) (Equation 1)

rₜ=σ(WᵣLᵢⱼ+Uᵣhₜ₋₁+bᵣ) (Equation 2)

yₜ=tanh(Wₕlₜ+rₜ·(Uₕhₜ₋₁+bₕ) (Equation 3)

hₜ=(1−gₜ)·hₜ₋₁+gₜ·yₜ (Equation 4)

yᵢⱼ^{k}=GRU(lᵢⱼ^{k}) (Equation 5),

where i∈[1,M] and j∈[1,N]; W, U, and b represent parameter matrices; k represents the GRU cell, GRU represents each individual GRU cell of the GRU 410, yₜ is the candidate activity vector, and hₜ is the output vector.

Equations executed by the attention layer 415:

$$\begin{matrix}{u}_{i j} = tanh ( {W}_{w} {y}_{i j} + {b}_{w} ) & ( Equation 6 ) \\ {a}_{i j} = \frac{exp ( {u}_{i j}^{T} {u}_{w} )}{{\sum }_{j = 1}^{N} exp ( {u}_{i j}^{T} {u}_{w} )} & ( Equation 7 )\end{matrix}$$

Sᵢ=Σⱼ₌₁^{N}aᵢⱼyᵢⱼ (Equation 8),

where Sᵢ is the context vector, aᵢⱼ is the weight of the annotation yᵢⱼ (such that the encoder of the attention layer 415 maps the input sentence to the annotations yᵢⱼ), and uᵢⱼ is an alignment model which scores how well the inputs around position j and the output at position i match.

FIG. 5 depicts an example of the duration layer 120 of the predictive analysis system 110, according to some aspects of the present disclosure. As illustrated in FIG. 5, the Week #1 vector representation, which is outputted by the activity layer 115 in FIG. 4, along with the Week #2 vector representation, Week #3 vector representation, Week #4 vector representation, and so on, are inputted into the duration layer 120. Each week vector representation is inputted into GRU 510. The GRU 510 is similar to the GRU 410, as shown in FIG. 4, and thus, a description of GRU 510 is omitted here. A rolling window is defined as the period over which the interactions of a user of the group of users are evaluated to generate the prediction parameter for the next time duration. For example, a rolling window of the most recent four weeks indicates that the interactions of a specific user of the group of users over the most recent four weeks are evaluated to generate a prediction of the collective group decision for the following week (e.g., the fifth week).

The outputs of the GRU 510 are then passed to attention layer 515. For example, the attention layer 515 is a hierarchical attention network, which is similar to the attention layer 415 illustrated in FIG. 4. The attention layer 515 is trained using previous week vector representations to detect which interactions to focus on (e.g., to attend to), and this information is passed on as contextual information in the form of an initial User #1 Vector Representation, which represents the interactions of User #1 over the rolling window. The initial User #1 Vector Representation is then passed on to the entity layer 125 (not shown in FIG. 5). Additionally, the initial User #1 Vector Representation is used to obtain weights for each user of the group of users, which is then used as a proxy measure of influence of the user in the final prediction (e.g., the prediction parameter).

The predictive analysis system 110 concatenates the initial User #1 Vector Representation with one or more user-specific features 520 to generate the final User #1 Vector Representation 525, which is then inputted into the entity layer 125 (not shown in FIG. 5).

The equations executed by the cells of the GRU 510 and the attention layer 515 are as follows:

\vec{fᵢ^{k}}=\vec{GRU(Sᵢ)}, where i∈[1,M] (Equation 9)

[symbol]

=\vec{GRU(Sᵢ)}, where i∈[M,1] (Equation 10)

uᵢ=tanh(Wₛfᵢ+bₛ) (Equation 11)

$${a}_{i} = \frac{exp ( {u}_{i}^{T} {u}_{s} )}{{\sum }_{j = 1}^{N} exp ( {u}_{i}^{T} {u}_{s} )} , \qquad ( Equation 12 )$$

where \vec{fᵢ^{k}} represents a forward recurrent neural network, and [symbol] represents a backward recurrent neural network.

In some implementations, the cross-entropy loss function is expressed as follows:

L=−a log(z), where “a” is the ground truth label and “z” is the actual output.

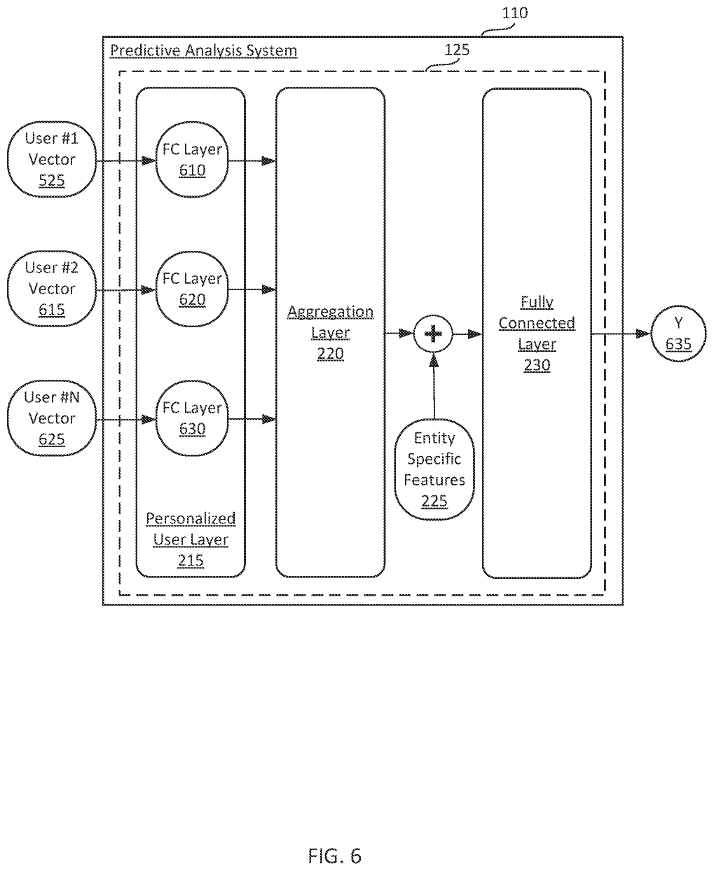

FIG. 6 depicts an example of the entity layer 125 of the predictive analysis system 110, according to some aspects of the present disclosure. Continuing with the example described in FIG. 5, the duration layer 120 generates a final user vector representation for each user of the group of users associated with the requesting entity. As illustrated in FIG. 6, the predictive analysis system 110 receives as input the final vector representation for each user of the group of users. For example, the entity layer 125 receives the final User #1 Vector Representation 525 for user #1, the final User #2 Vector Representation 615 for user #2, and so on until the final User #N Vector Representation 625 for user #N (representing the last user of the group).

Each user vector representation is inputted into a separate fully-connected layer. For example, final User #1 Vector Representation 525 for user #1 is inputted into fully-connected layer 610, the final User #2 Vector Representation 615 for user #2 is inputted into fully-connected layer 620, and so on until the final User #N Vector Representation 525 for user #N is inputted into fully-connected layer 630. Each of fully-connected layers 610 through 630 generates an output that is passed on to the aggregation layer 220.

The aggregation layer 220 receives the output from each fully-connected layer 610, 620, and 630, and aggregates the received outputs into an aggregated vector representation. In some implementations, the aggregation layer 220 aggregates the outputs of the fully-connected layers 610, 620, and 630 using a feedforward neural network. The number of hidden layers of the feedforward neural network is changeable. As an illustrative example, the aggregation layer 220 includes two hidden layers followed by a Sigmoid layer to generate the output as a probability of that the collective decision of the group of users will be to request an item from the providing entity. In other implementations, the aggregation layer 220 is a many-to-many GRU layer. The many-to-many GRU layer receives the outputs of fully-connected layers 610, 620, and 630 and generates an output. The output of the many-to-many GRU layer is then passed into an attention layer attention layer (similar to the activity layer 115 and the duration layer 120 described above). The output of the attention layer is concatenated with one or more entity-specific features 225, and the resulting output is passed on to a final fully-connected layer 230 (e.g., a fully-connected feedforward neural network) to generate the output Y 635 (e.g., the prediction parameter).

In other implementations, the aggregation layer 220 includes a many-to-one GRU to generate the output Y 635. For example, the output of each fully-connect layer 610, 620, and 630 is inputted into the many-to-one GRU layer included in the aggregation layer 220. The output from the many-to-one GRU layer is concatenated with the one or more entity-specific features 225, and the resulting vector is then inputted into the fully-connected layer 230 (e.g., a fully-connected feedforward neural network) to generate the output Y 635.

In other implementations, the aggregation layer 220 executes logic for determining the output Y 635. For example, the aggregation layer 220 evaluates each of the outputs of fully-connected layers 610, 620, and 630 to detect if exactly one user vector representations indicates that the correspond user decided to request an item from the providing entity. If so, then the requesting entity is predicted to request the item from the providing entity. In this example, the likelihood that the collective group of users will decide to request the item from the providing entity is determined by identifying the user vector representation that has the maximum value. In other words, the user vector representation that was identified as having the maximum value is used as the prediction of the decision made by the collective group for the requesting entity. In other implementations, instead of detecting whether exactly one user has requested the item from the providing entity, the aggregation layer 220 detects whether at least one user has decided to request the item from the providing entity. In this case, the predictive analysis system predicts that the collected group of users of the requesting entity will request the item from the providing entity. In other implementations, the aggregation layer 220 aggregates the outputs of the fully-connected layers 610, 620, and 630 and computes the geometric mean. The present disclosure is not limited to the aggregation techniques described above.

Regardless of technique used to aggregate the outputs of the fully-connected layers 610, 620, and 630, the entity layer 125 concatenates the aggregated output with one or more entity-specific features (e.g., size of the requesting entity, industry of requesting entity, firmographics, etc.), and the resulting vector is inputted into a final fully-connected layer 230 to generate the output Y 630, which is a value that represents the probability that the collective group will decide to request the item from the providing entity during the following time duration (e.g., during the following week).

FIG. 7 depicts an example of a process for generating a prediction of a probability of a business making a purchase from a supplier within a defined time duration, according to some aspects of the present disclosure. Process 700 is performed at least in part by any of the hardware-based computing devices illustrated in FIGS. 1-6 or FIGS. 8-9. For example, process 700 is performed by one or more servers included in the cloud system 100, the engagement automation system 105, or the predictive analysis system 110. As a further example, the predictive analysis system 110 performs process 700 as part of a dashboard that presents an interface to an individual of the providing entity. The interface presents a visual indicator of the prediction parameter, which represents the probability that a given requesting entity will request an item from the providing entity during the next time duration (e.g., the next week, the next bi-week, etc.).

At block 705, the predictive analysis system 110 identifies or automatically detects a set of users associated with a requesting entity. For example, the requesting entity is a business potentially requesting (e.g., purchasing) one or more items (e.g., a product or service) from the providing entity (e.g., a supplier). The set of users includes individuals employed by the requesting entity. The set of users are tasked with collectively determining whether or not to request an item from the providing entity. For example, a user of the set of users may be an employee in the marketing department of the requesting entity, and another user of the set of users may be an employee in the finance department of the requesting entity.

After the predictive analysis system 110 identifies the set of users associated with a requesting entity, then the predictive analysis system 110 performs blocks 710, 715, and 720 for each user of the set of users. At block 710, the predictive analysis system 110 access behavior logs for each user over the time period of a predefined rolling window. For example, the rolling window includes one or more recent time durations (e.g., the most recent four weeks). If the interactions are to be represented as a sequence, then at block 715, the interactions in the behavior log of the last time duration associated with the user are inputted into the activity layer 115 to generate the duration vector representation. If the interactions are to be represented as a frequency distribution, then at block 715, then the predictive analysis system 110 generates an input vector to represent the frequency distribution of the interactions that occurred within the last time duration within the rolling window. The input vector represents the duration vector representation. At block 720, the duration vector for each time duration within the rolling window is inputted into the duration layer 120, and the output of the duration layer 120 is the user vector representation for that user. The user vector representation is concatenated with one or more user-specific features that characterize that user.

At block 725, the entity layer 125 receives the user vector representation for each user of the set of users associated with the requesting entity. For each user, the entity layer 125 processes the user vector representation using a separate fully-connected layer. The entity layer 125 aggregates the output of each fully-connected layer using various aggregation techniques described above. The entity layer 125 concatenates the aggregated out with one or more entity-specific features (e.g., firmographics) to generate the entity vector representation to numerically represent the interactions of the set of users over the course of the rolling window.

At block 730, the entity layer 125 passes the entity vector representation to a final fully-connected layer to generate the prediction parameter (e.g., output Y). The prediction parameter represents the probability that the set of users will collectively decide to request one or more items from the providing entity during the following time duration. In some implementations, the predictive analysis system 110 automatically performs one or more responsive actions in response to the prediction parameter. For example, the predictive analysis system 110 presents the prediction parameter for the requesting entity on an interface (e.g., a dashboard). As another example, the predictive analysis system 110 can execute one or more rules to determine a responsive action. A rule includes generating a communication (e.g., an email or push notification) and transmitting the communication to an individual associated with the providing entity as a notification of the prediction parameter. Another rule includes comparing the prediction parameter (e.g., which is represented as a score) to one or more thresholds. If the prediction parameter is equal to or exceeds a threshold, then the predictive analysis system 110 can automatically generate content or modify existing content of a communication configured for transmission to one or more of the users of the set of users. For example, generating content of a communication includes generating an email and text to include in the body of the email, which is configured to be transmitted to one or more users of the set of users. As another example, modifying existing content of a communication includes modifying text or hyperlinks included in the existing content in response to the prediction parameter. To illustrate, if the prediction parameter is 0.8, which is above a threshold of 0.5, then the prediction analysis system 110 interprets the prediction parameter as indicating that the collective set of users is very likely to decide to request an item from the providing entity during the next week. In response, the standard text of emails to the users are modified to change the language or to include a link to directly request the item, in light of the high likelihood that the request for the item.

### Examples of Computing Environments for Implementing Certain Implementations

Any suitable computing system or group of computing systems can be used for performing the operations described herein. For example, FIG. 9 depicts an example of computing device 900 that may be at least a portion of cloud system 100. The implementation of the computing device 900 could be used for one or more of the engagement automation system 105 or the user system 135. In an implementation, a single cloud system 100 having devices similar to those depicted in FIG. 9 (e.g., a processor, a memory, etc.) combines the one or more operations and data stores depicted as separate subsystems in FIG. 1. Further, FIG. 8 illustrates a cloud computing system 800 by which at least a portion of the cloud system 100 may be offered.

In some implementations, the functionality provided by the cloud system 100 may be offered as cloud services by a cloud service provider. For example, FIG. 8 depicts an example of a cloud computing system 800 offering an image editing service that can be used by a number of user subscribers using user devices 825a, 825b, and 825c across a data network 820. In the example, the image editing service may be offered under a Software as a Service (SaaS) model. One or more users may subscribe to the image editing service, and the cloud computing system performs the processing to provide the image editing service to subscribers. The cloud computing system may include one or more remote server computers 805.

The remote server computers 805 include any suitable non-transitory computer-readable medium for storing program code (e.g., a cloud system 100) and program data 810, or both, which is used by the cloud computing system 800 for providing the cloud services. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript. In various examples, the server computers 805 can include volatile memory, non-volatile memory, or a combination thereof.

One or more of the servers 805 execute the program code 810 that configures one or more processors of the server computers 805 to perform one or more of the operations, including the predictive analysis functionality performable by the predictive analysis system 110 to perform shot-matching and other image editing techniques. As depicted in the implementation in FIG. 8, the one or more servers providing the services to perform predictive analysis functionality via the prediction analysis system 110 may include access to the models of the prediction analysis system 110 including the activity layer 115, the duration layer 120, and the entity layer 125. Any other suitable systems or subsystems that perform one or more operations described herein (e.g., one or more development systems for configuring an interactive user interface) can also be implemented by the cloud computing system 800.

In certain implementations, the cloud computing system 800 may implement the services by executing program code and/or using program data 810, which may be resident in a memory device of the server computers 805 or any suitable computer-readable medium and may be executed by the processors of the server computers 805 or any other suitable processor.

In some implementations, the program data 810 includes one or more datasets and models described herein. Examples of these datasets include image data, new image content, image energy data, etc. In some implementations, one or more of data sets, models, and functions are stored in the same memory device. In additional or alternative implementations, one or more of the programs, data sets, models, and functions described herein are stored in different memory devices accessible via the data network 815.

The cloud computing system 800 also includes a network interface device 815 that enable communications to and from cloud computing system 800. In certain implementations, the network interface device 815 includes any device or group of devices suitable for establishing a wired or wireless data connection to the data networks 820. Non-limiting examples of the network interface device 815 include an Ethernet network adapter, a modem, and/or the like. The cloud system 100 is able to communicate with the user devices 825a, 825b, and 825c via the data network 820 using the network interface device 815.

FIG. 9 illustrates a block diagram of an example computer system 900. Computer system 900 can be any of the described computers herein including, for example, engagement automation system 105, user system 135, or server computer 805. The computing device 900 can be or include, for example, a laptop computer, desktop computer, tablet, server, or other electronic device.

The computing device 900 can include a processor 935 interfaced with other hardware via a bus 905. A memory 910, which can include any suitable tangible (and non-transitory) computer readable medium, such as RAM, ROM, EEPROM, or the like, can embody program components (e.g., program code 915) that configure operation of the computing device 800. Memory 910 can store the program code 915, program data 917, or both. In some examples, the computing device 900 can include input/output (“I/O”) interface components 925 (e.g., for interfacing with a display 940, keyboard, mouse, and the like) and additional storage 930.

The computing device 900 executes program code 915 that configures the processor 935 to perform one or more of the operations described herein. Examples of the program code 915 include, in various implementations, the prediction analysis system 110 including the activity layer 115, the duration layer 120, and the entity layer 125, the predictive analysis function, or any other suitable systems or subsystems that perform one or more operations described herein (e.g., one or more development systems for configuring an interactive user interface). The program code 915 may be resident in the memory 910 or any suitable computer-readable medium and may be executed by the processor 940 or any other suitable processor.

The computing device 900 may generate or receive program data 917 by virtue of executing the program code 915. For example, the source image and modified source image are all examples of program data 917 that may be used by the computing device 900 during execution of the program code 915.

The computing device 900 can include network components 920. Network components 920 can represent one or more of any components that facilitate a network connection. In some examples, the network components 920 can facilitate a wireless connection and include wireless interfaces such as IEEE 802.11, Bluetooth, or radio interfaces for accessing cellular telephone networks (e.g., a transceiver/antenna for accessing CDMA, GSM, UMTS, or other mobile communications network). In other examples, the network components 920 can be wired and can include interfaces such as Ethernet, USB, or IEEE 1394.

Although FIG. 9 depicts a single computing device 900 with a single processor 935, the system can include any number of computing devices 900 and any number of processors 935. For example, multiple computing devices 900 or multiple processors 935 can be distributed over a wired or wireless network (e.g., a Wide Area Network, Local Area Network, or the Internet). The multiple computing devices 900 or multiple processors 935 can perform any of the steps of the present disclosure individually or in coordination with one another.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific implementations thereof, it will be appreciated that those skilled in the art, upon attaining an understanding of the foregoing, may readily produce alterations to, variations of, and equivalents to such implementations. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

1. A computer-implemented method, comprising:
identifying a set of users associated with a requesting entity;
for each user of the set of users:
accessing one or more behavior logs associated with the user captured during a duration, each behavior log of the one or more behavior logs characterizing one or more interactions between a user device operated by the user and a network associated with a providing entity;
generating a duration vector representation representing the one or more behavior logs that occurred within the duration, the duration vector representation being generated using a first trained machine-learning model;
generating a user vector representation by inputting the duration vector representation into an attention layer, the user vector representation including one or more user-specific features concatenated with an output of the attention layer; and
inputting the user vector representation into a second trained machine-learning model that is associated with the user;
aggregating the output of the second trained machine-learning model associated with each user of the set of users into an entity vector representation representing the requesting entity, the entity vector representation including one or more entity-specific features concatenated with an output of the second trained machine-learning model;
generating a prediction of a decision that the set of users will make on behalf of the requesting entity during a next duration, the decision corresponding to one or more items provided by the providing entity, and the prediction of the decision being generated by inputting the entity vector representation into a third trained machine-learning model; and
causing one or more responsive actions in response to the prediction of the decision.

2. The computer-implemented method of claim 1, wherein generating the duration vector representation further comprises:
determining a frequency distribution of the one or more interactions between the user device operated by the user and the network associated with, wherein the one or more interactions is associated with at least one activity type from a set of activity types; and
representing the duration vector representation as a vector having a length corresponding to a number activity types in the set of activity types.

3. The computer-implemented method of claim 1, wherein generating the duration vector representation further comprises:
for each interaction of the one or more interactions that occurred within the duration:
generating an activity vector representation to numerically represent the interaction, the activity vector representation being generated by inputting the interaction into a fourth trained machine-learning model;
inputting the activity vector representation for each interaction of the one or more interactions into another attention layer; and
generating the duration vector representation using an output of the another attention layer.

4. The computer-implemented method of claim 1, wherein the next duration is a future time period, wherein the duration is a past time period, and wherein the decision that the set of users will make on behalf of the requesting entity is determined on a rolling basis, such that at an end of the next duration, another prediction of the decision that the set of users will make on behalf of the requesting entity is determined for another next duration.

5. The computer-implemented method of claim 1, wherein aggregating the output of the second trained machine-learning model associated with each user of the set of users further comprises:
inputting the user vector representation for each user of the set of users and the one or more entity-specific features into a feedforward neural network; and
generating the prediction of the decision that the set of users will make on behalf of the requesting entity during the next duration, the prediction being generated using an output of the feedforward neural network.

6. The computer-implemented method of claim 1, wherein aggregating the output of the second trained machine-learning model associated with each user of the set of users further comprises:
inputting the user vector representation for each user of the set of users into a many-to-one gated recurrent unit (GRU);
concatenating an output of the GRU with the one or more entity-specific features;
inputting the output of the GRU concatenated with the one or more entity-specific features into a feedforward neural network; and
generating the prediction of the decision that the set of users will make on behalf of the requesting entity during the next duration, the prediction being generated using an output of the feedforward neural network.

7. The computer-implemented method of claim 1, wherein aggregating the output of the second trained machine-learning model associated with each user of the set of users further comprises:
detecting a behavior performed by at least one user of the set of users, the detection being based on the user vector representation of the at least one user; and
generating the prediction of the decision that the set of users will make on behalf of the requesting entity during the next duration, the prediction being generated based on the detection of the behavior performed by the at least one user.

8. A system comprising:
one or more processors; and
a non-transitory computer-readable medium communicatively coupled to the one or more processors and storing program code executable by the one or more processors, the program code implementing a predictive analysis system configured to predict a decision that a set of users will make on behalf of a requesting entity, the predictive analysis system comprising:
a duration layer configured to generate a duration vector representation for each user of the set of users associated with the requesting entity, the duration vector representation representing one or one or more behavior logs associated with the user, each behavior log of the one or more behavior logs being captured during a duration and characterizing one or more interactions between a user device operated by the user and a network associated with a providing entity;
a personalized user model configured to generate a user vector representation for each user of the set of users, the user vector representation representing contextual information associated with the one or more behavior logs associated with the user;
an aggregation layer configured to aggregate the user vector representation for each user of the set of users into an entity vector representation; and
a fully-connected layer configured to predict the decision that the set of users will make on behalf of the requesting entity during a next duration, the decision corresponding to one or more items provided by the providing entity, and the prediction of the decision being generated by inputting the entity vector representation into the fully-connected layer, wherein the prediction of the decision causes the predictive analysis system to perform one or more responsive actions.

9. The system of claim 8, wherein the duration layer is further configured to:
determine a frequency distribution of the one or more interactions between the user device operated by the user and the network associated with the providing entity, wherein the one or more interactions is associated with at least one activity type from a set of activity types; and
represent the duration vector representation as a vector having a length corresponding to a number activity types in the set of activity types.

10. The system of claim 8, wherein the duration layer is further configured to include an activity layer, wherein the activity layer is configured to:
for each interaction of the one or more interactions that occurred within the duration:
generate an activity vector representation to numerically represent the interaction, the activity vector representation being generated by inputting the interaction into a fourth trained machine-learning model;
input the activity vector representation for each interaction of the one or more interactions into another attention layer; and
generate the duration vector representation using an output of the another attention layer.

11. The system of claim 8, wherein the next duration is a future time period, wherein the duration is a past time period, and wherein the decision that the set of users will make on behalf of the requesting entity is determined on a rolling basis, such that at an end of the next duration, another prediction of the decision that the set of users will make on behalf of the requesting entity is determined for another next duration.

12. The system of claim 8, wherein the aggregation layer is further configured to:
input the user vector representation for each user of the set of users and one or more entity-specific features into a feedforward neural network; and
generating the prediction of the decision that the set of users will make on behalf of the requesting entity during the next duration, the prediction being generated using an output of the feedforward neural network.

13. The system of claim 8, wherein the aggregation layer is further configured to:
input the user vector representation for each user of the set of users into a many-to-one gated recurrent unit (GRU);
concatenate an output of the GRU with one or more entity-specific features;
input the output of the GRU concatenated with the one or more entity-specific features into a feedforward neural network; and
generating the prediction of the decision that the set of users will make on behalf of the requesting entity during the next duration, the predicting being generated using an output of the feedforward neural network.

14. A computer-implemented method, comprising:
accessing one or more behavior logs associated with a user of a set of users associated with a requesting entity, each behavior log of the one or more behavior logs being captured during a duration and characterizing one or more interactions between a user device operated by the user and a network associated with a providing entity; and
a step for predicting a decision that the set of users will make on behalf of the requesting entity during a next duration associated with a future time period.

15. The computer-implemented method of claim 14, wherein the step for predicting the decision that the set of users will make on behalf of the requesting entity during the next duration further comprises:
determining a frequency distribution of the one or more interactions between the user device operated by the user and the network associated with the providing entity, wherein the one or more interactions is associated with at least one activity type from a set of activity types; and
representing a duration vector representation as a vector having a length corresponding to a number activity types in the set of activity types.

16. The computer-implemented method of claim 14, wherein the step for predicting the decision that the set of users will make on behalf of the requesting entity during the next duration further comprises:
for each interaction of the one or more interactions that occurred within the duration:
generating an activity vector representation to numerically represent the interaction, the activity vector representation being generated by inputting the interaction into a fourth trained machine-learning model;
inputting the activity vector representation for each interaction of the one or more interactions into another attention layer; and
generating a duration vector representation using an output of the another attention layer.

17. The computer-implemented method of claim 14, wherein the next duration is a future time period, wherein the duration is a past time period, and wherein the decision that the set of users will make on behalf of the requesting entity is determined on a rolling basis, such that at an end of the next duration, another prediction of the decision that the set of users will make on behalf of the requesting entity is determined for another next duration.

18. The computer-implemented method of claim 14, wherein the step for predicting the decision that the set of users will make on behalf of the requesting entity during the next duration further comprises:
inputting a user vector representation for each user of the set of users and one or more entity-specific features into a feedforward neural network; and
generating a prediction of a decision that the set of users will make on behalf of the requesting entity during the next duration, the prediction being generated using an output of the feedforward neural network.

19. The computer-implemented method of claim 14, wherein the step for predicting the decision that the set of users will make on behalf of the requesting entity during the next duration further comprises:
inputting a user vector representation for each user of the set of users into a many-to-one gated recurrent unit (GRU);
concatenating an output of the GRU with one or more entity-specific features;
inputting the output of the GRU concatenated with the one or more entity-specific features into a feedforward neural network; and
generating a prediction of a decision that the set of users will make on behalf of the requesting entity during the next duration using an output of the feedforward neural network.

20. The computer-implemented method of claim 14, wherein the step for predicting the decision that the set of users will make on behalf of the requesting entity during the next duration further comprises:
detecting a behavior performed by at least one user of the set of users, the detection being based on a user vector representation of the at least one user; and
generating the prediction of the decision that the set of users will make on behalf of the requesting entity during the next duration, the prediction being generated based on the detection of the behavior performed by the at least one user.
